(19) United States
(12) Patent Application Publication
(10) Pub. No.: US 2024/0051252 A1
(43) Pub. Date: Feb. 15, 2024

(54) tablet punch

(71) Applicant: I HOLLAND LIMITED, Nottingham (GB)

(72) Inventor: Stephen John OSBORN, Nottingham (GB)

(21) Appl. No.: 18/447,764

(22) Filed: Aug. 10, 2023

(30) Foreign Application Priority Data
Aug. 10, 2022 (GB) 2211701.4

(51) Int. Cl. B30B 15/06; B30B 11/04; A61J 3/10

(52) U.S. Cl. CPC B30B 15/065; B30B 11/04; A61J 3/10

(57) ABSTRACT

A tablet punch. The tablet punch comprises an elongate fastener having a longitudinal extent, one or more punch components, each punch component having a longitudinal extent and being arranged to receive the elongate fastener, and a head component. The head component, configured to connect the tablet punch to a tablet compression machine, is arranged to receive the one or more punch components and the elongate fastener such that the elongate fastener fixedly connects the one or more punch components and the head component together. When the elongate fastener fixedly connects the head component and the one or more punch components together, the longitudinal extent of the elongate fastener is orientated substantially orthogonally relative to the longitudinal extent of the one or more punch components.

### CROSS REFERENCE TO RELATED APPLICATIONS

This application claims priority to GB2211701.4 filed Aug. 10, 2022, the entire contents of which are incorporated by reference herein.

### TECHNOLOGICAL FIELD

Embodiments of the present disclosure relate to a tablet punch.

### BACKGROUND

Tablet compression machines are used to form tablets, e.g., pharmaceuticals. Some tablet compression machines comprise a plurality of dies and tablet punches. The dies contain powder of a particular material from which a tablet is to be formed. Two tablet punches enter a die from opposing sides to compress the powder into tablets.

### BRIEF SUMMARY

According to various, but not necessarily all, embodiments there is provided a tablet punch. The tablet punch comprises an elongate fastener having a longitudinal extent, one or more punch components, each punch component having a longitudinal extent and being arranged to receive the elongate fastener, and a head component. The head component, configured to connect the tablet punch to a tablet compression machine, is arranged to receive the one or more punch components and the elongate fastener such that the elongate fastener fixedly connects the one or more punch components and the head component together. When the elongate fastener fixedly connects the head component and the one or more punch components together, the longitudinal extent of the elongate fastener is orientated substantially orthogonally relative to the longitudinal extent of the one or more punch components.

The head component may comprise one or more respective holes arranged to receive a portion of the one or more punch components when the one or more punch components are fixedly connected to the head component.

The head component may comprise a fastening hole arranged to receive the elongate fastener when the one or more punch components are fixedly connected to the head component.

The fastening hole may have a longitudinal extent that is orientated substantially orthogonally relative to the longitudinal extent of the one or more punch components when the one or more punch components are fixedly connected to the head component.

Each punch component may comprise a hole arranged to receive the elongate fastener when the one or more punch components are fixedly connected to the head component.

The hole of each punch component may have a longitudinal extent that is orientated substantially orthogonally relative to the longitudinal extent of the punch component.

The hole of each punch component may be a through hole.

When the one or more punch components are fixedly connected to the head component, the hole of the punch components may be at least partially aligned with the fastening hole.

When the one or more punch components are fixedly connected to the head component, a clearance may be formed between an end face of the punch component and the head component.

Each punch component may comprise a shoulder arranged to abut against an external surface of the head component when the punch component is fixedly connected to the head component.

The shoulder may be intermediate a punching portion and a connection portion of the punch component. The respective holes of the head component may be arranged to receive the connection portion of the punch component. The depth of the respective holes may be greater than a longitudinal extent of the connection portion.

When the shoulder abuts against an external surface of the head component, the hole of the punch components and the fastening hole may be only partially aligned.

The elongate fastener may be a coiled spring pin.

The head component may comprise a notch configured to align the tablet punch when connected to the tablet compression machine.

The head component may comprise a connector arranged to connect the tablet punch to the tablet compression machine. The connector may comprise a recess. The connector may comprise a slanted edge.

The head component may comprise at least one groove having a longitudinal extent. When the one or more punch components is fixedly connected to the head component, the longitudinal extent of the at least one groove may be orientated substantially orthogonally relative to the longitudinal extent of the elongate fastener and the longitudinal extent of the one or more punch components.

The head component may comprise two grooves. The fastening hole may extend from one groove to the other groove.

According to various, but not necessarily all, embodiments there is provided a tablet punch. The tablet punch comprises one or more punch components, each punch component having a shoulder, a head component, configured to connect the tablet punch to a tablet compression machine, arranged to receive the one or more punch components, and a fastener configured to fixedly connect the head component and the one or more punch components together. When the one or more punch components are received by the head component and fixedly connected by the fastener, the shoulder of each punch component abuts against an external surface of the head component.

When the one or more punch components are fixedly connected to the head component, a clearance may be formed between an end face of the punch component and the head component.

The head component may comprise one or more respective holes arranged to receive a portion of the one or more punch components when the one or more punch components are fixedly connected to the head component.

The shoulder may be intermediate a punching portion and a connection portion of the punch component. The respective holes of the head component may be arranged to receive the connection portion of the punch component.

The head component may comprise a fastening hole arranged to receive the fastener when the one or more punch components are fixedly connected to the head component.

Each punch component may comprise a hole arranged to receive the fastener when the one or more punch components are fixedly connected to the head component. The hole of the punch components may have a longitudinal extent that is orientated substantially orthogonally relative to a longitudinal extent of the one or more punch components.

When the shoulder abuts against an external surface of the head component, the hole of the punch components and the fastening hole may be only partially aligned.

According to various, but not necessarily all, embodiments there is provided a tablet punch. The tablet punch comprises one or more punch components, a head component, configured to connect the tablet punch to a tablet compression machine, comprising one or more respective holes to receive the one or more punch components, and a fastener configured to fixedly connect the head component and the one or more punch components together. When the head component and the one or more punch components are fixedly connected by the fastener, a portion of the one or more punch components is located within the one or more respective holes.

According to various, but not necessarily all, embodiments there is provided examples as claimed in the appended claims.

### BRIEF DESCRIPTION

Some examples will now be described with reference to the accompanying drawings in which:

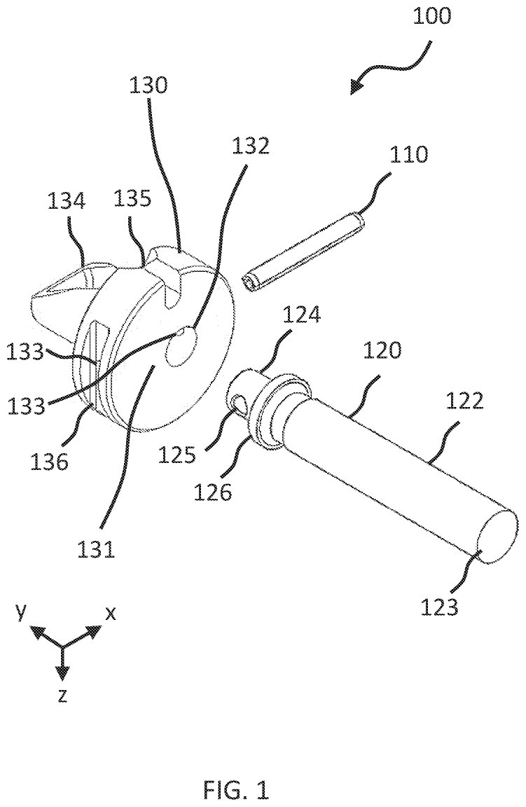

FIG. 1 shows an exploded view of a first example tablet punch;

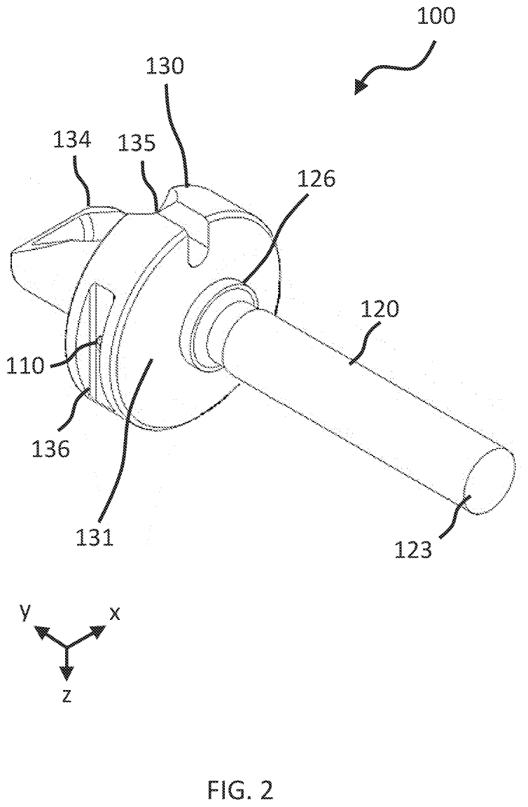

FIG. 2 shows a schematic diagram of the first example tablet punch assembled;

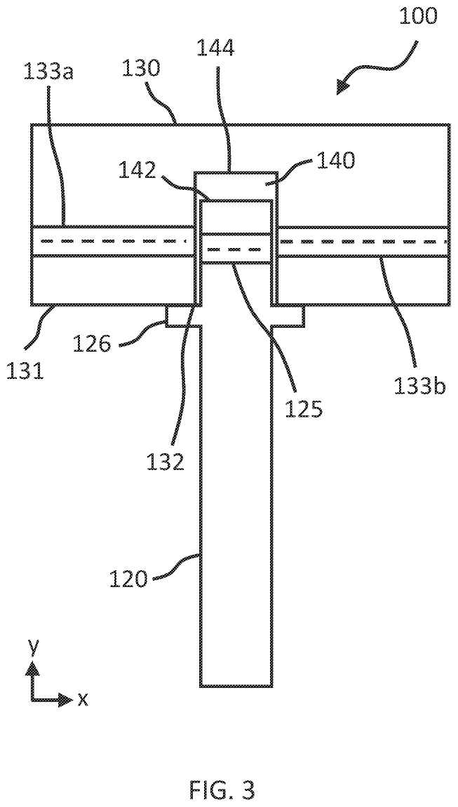

FIG. 3 shows a cross sectional view of the assembled first example tablet punch;

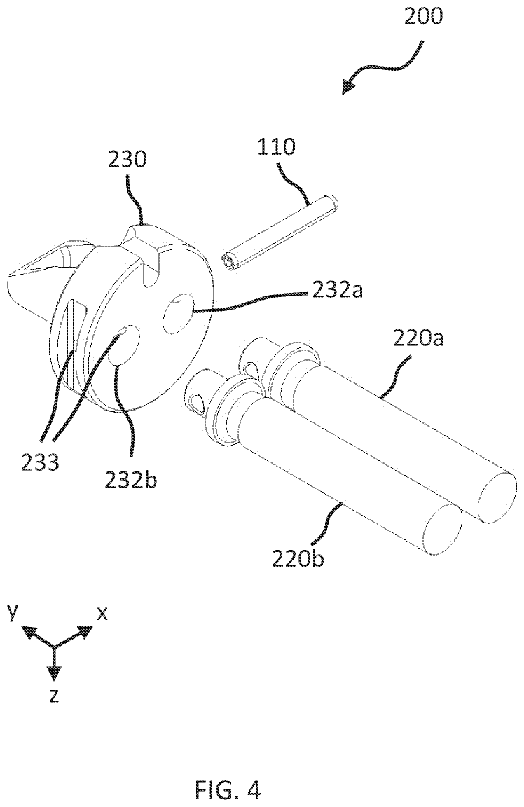

FIG. 4 shows an exploded view of a second example tablet punch;

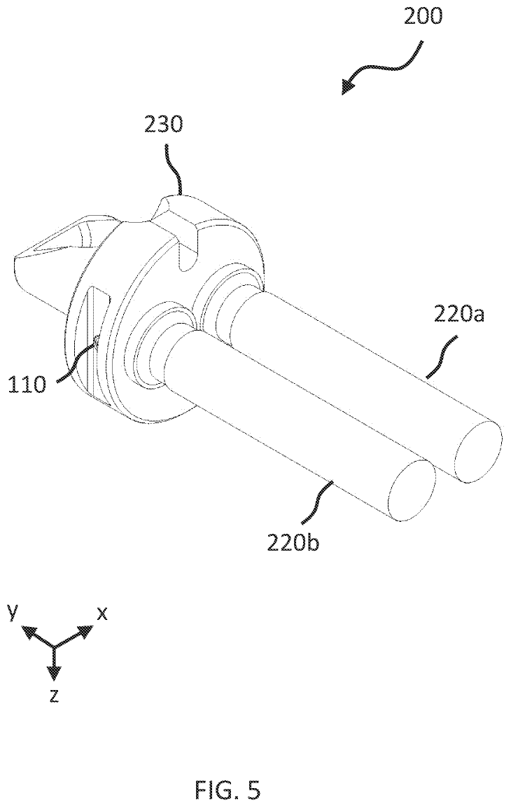

FIG. 5 shows a schematic diagram of the second example tablet punch assembled; and

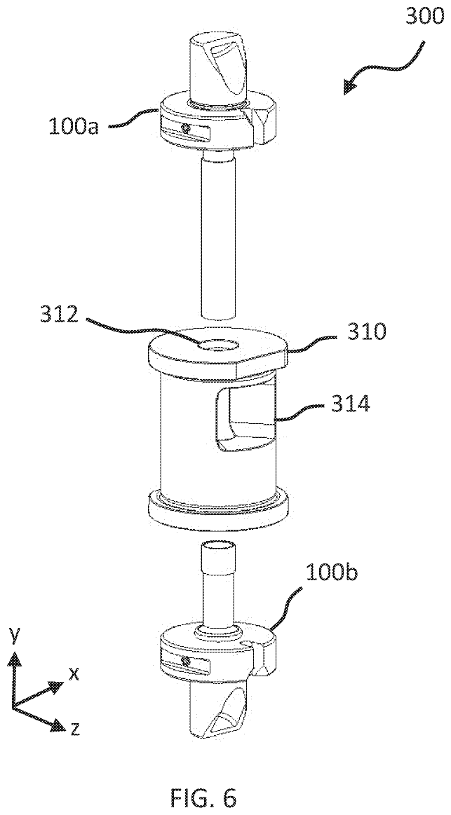

FIG. 6 shows a schematic diagram of two assembled first example tablet punches and a die.

### DETAILED DESCRIPTION

Embodiments of the invention relate to a tablet/pill punch. The tablet punch is to be connected to a tablet compression machine to form tablets/pills, such as pharmaceuticals.

FIG. 1 shows an exploded view of a first example tablet punch 100 for a tablet compression machine. The first example tablet punch 100 comprises an elongate fastener 110, a punch component 120, and a head component 130. The punch component 120 and the head component 130 are to be fixedly (and removably) connected together by the elongate fastener 110. In particular, the punch component 120 is arranged to receive the elongate fastener 110, and the head component 130 is arranged to receive the punch component 120 and the elongate fastener 110. In the illustrated example, the elongate fastener 110 is to be received by the punch component 120 and the head component 130 in the x-dimension. The punch component 120 is for forming tablets in a die (which contains powder to be formed into tablets) and the head component 130 is configured to connect the tablet punch 100 to a tablet compression machine.

The elongate fastener 110 and the punch component 120 each have a longitudinal extent, i.e., a length. The length is the longest aspect of the component 110, 120. That is, the length of a component 110, 120 is greater than the width and the depth of that component 110, 120. In some examples, the length may be at least three times greater than the width and the depth, and in some further examples it might be at least five times greater. The width may be greater than, smaller than or substantially the same as the depth. In FIG. 1, the longitudinal extent of the elongate fastener 110 is aligned with the x-dimension and the longitudinal extent of the punch component 120 is aligned with the y-dimension.

In the illustrated example, the elongate fastener 110 is a coiled spring pin. In other embodiments, the elongate fastener 110 may be a different form of fastener, such as a peg, a rivet or a screw.

The punch component 120 illustrated in FIG. 1 comprises a punching portion 122 for forming tablets and a connection portion 124 for connection to the head component 130. The punching portion 122, which is to be at least partially received by a die of the tablet compression machine, comprises a punching surface 123 which contacts powder in the die of the tablet compression machine to form tablets. In the illustrated example, the punching portion 122 is cylindrical in shape. However, it may have any shape based on the desired shape for the formed tablets. The connection portion 124 comprises an end face which is separated from the punching surface 123 by the longitudinal extent of the punch component 120.

The illustrated punch component 120 comprises a hole 125, in the connection portion 124, arranged to receive the elongate fastener 110 when the punch component 120 is fixedly connected to the head component 130. The hole 125 of the punch component 120 has a longitudinal extent, i.e., length, that is orientated substantially orthogonally relative to the longitudinal extent of the punch component 120. In the illustrated example, the longitudinal extent of the hole 125 is aligned with the x-dimension. In this example, the hole 125 is a through hole, but in some embodiments the hole 125 may be a blind hole. In some embodiments, the hole 125 may be two blind holes aligned in the x-dimension which are separated by an intermediate section.

The punch component 120 of FIG. 1 also comprises a shoulder 126. The shoulder 126 is intermediate the punching portion 122 and the connection portion 124 of the punch component 120 (in the y-dimension). In particular, the punching portion 122, the shoulder 126 and the connection portion 124 are aligned along the dimension defined by the longitudinal extent of the punch component 120, i.e., the y-dimension as illustrated in FIG. 1. When the punch component 120 is fixedly connected to the head component 130, the shoulder 126 abuts against an external surface 131 of the head component 130. The shoulder 126 is illustrated as being cylindrical in shape. In other embodiments, the shoulder 126 may have any shape such that it abuts against the surface 131 when the punch component 120 is fixedly connected to the head component 130.

In the illustrated example, the punch component 120 is integrally formed. In other words, the punch component 120 is formed as a single, undivided piece. In other embodiments, the punch component 120 may be formed from multiple individual pieces connected together.

In some examples, one or more portions of the punch component 120 may be coated. The coating may be at least one of an anti-abrasion, anti-stick, anti-friction and/or anti-corrosion coating. The coating may be, for example, an alloy or a ceramic.

In FIG. 1, the head component 130 is arranged to receive the punch component 120. In particular, the head component 130 comprises a hole 132, in an external surface 131, arranged to receive a portion of the punch component 120 when the punch component 120 is fixedly connected to the head component 130. In the illustrated example, the hole 132 of the head component 130 is to receive the connection portion 124, i.e., all of the connection portion 124. Therefore, the hole 132 of the head component 130 has a depth, aligned with the y-dimension, which is greater than a longitudinal extent of the connection portion 124 (which is also aligned with the y-dimension) such that the shoulder 126 abuts against the surface 131 when the punch component 120 is fixedly connected to the head component 130. The hole 132 has the same shape as the connection portion 124. In the illustrated example, each of the connection portion 124 and the hole 132 are cylindrical in shape. The hole 132 has a diameter which is (at least slightly) greater than the diameter of the connection portion 124 and smaller than the diameter of the shoulder 126. In some examples, the hole 132 and the connection portion 124 may form an interference fit.

The head component 130 is also arranged to receive the elongate fastener 110 such that the elongate fastener 110 fixedly connects the punch component 120 and the head component 130 together. In particular, the head component 130 comprises a fastening hole 133 arranged to receive the elongate fastener 110 when the punch component 120 is fixedly connected to the head component 130. The fastening hole 133 extends at least partially through the head component 130. The fastening hole 133 has a longitudinal extent, i.e., a length, that is similar to the length of the elongate fastener 110. The longitudinal extent of the fastening hole 133 is orientated substantially orthogonally relative to the longitudinal extent of the one or more punch components when the punch component 120 is fixedly connected to the head component 130. In the illustrated example, the longitudinal extent of the fastening hole 133 is aligned with the x-dimension. The fastening hole 133 may be interconnected with the hole 132 that receives the punch component 120, for example, such that the fastening hole 133 extends from that hole 132. The fastening hole 133 may extend from both sides of the hole 132. This extension can be seen in the hole 132 illustrated in FIG. 1. The shape the fastening hole 133 is such that the hole 132 for receiving the punch component 120 extends further into the head component 130 in the y-dimension than the fastening hole 133, as illustrated in FIG. 3.

In some embodiments, the fastening hole 133 is a through hole, while in other embodiments it is a blind hole.

In the illustrated example, the tablet punch 100 comprises a single punch component 120 and a single respective hole 132 in the head component 130. However, in other embodiments, the tablet punch may comprise a plurality of punch components, see for example the second example tablet punch 200 illustrated in FIGS. 4 and 5, and described below. In some embodiments, the tablet punch only comprises one, two or three punch components. In other embodiments, the tablet punch comprises more than three punch components. When the tablet punch comprises a plurality of punch components, the head component comprises a respective hole for each punch component to be connected. Additionally, the shape of the plurality of punch components may be the same, or may differ from each other. For example, a single tablet punch may have one punch component that is cylindrical in shape and another that is cuboid in shape.

The head component 130 illustrated in FIG. 1 comprises at least one groove 136. Although not visible, the head component 130 may comprise another groove on the other side of the head component 130, i.e., towards the illustrated elongate fastener 110. The groove(s) 136 has/have a longitudinal extent, i.e., a length, which is aligned with the z-dimension of FIG. 1. In particular, when the punch component 120 is fixedly connected to the head component 130, the longitudinal extent of the groove(s) 136 is/are orientated substantially orthogonally relative to the longitudinal extent of the fastening hole 133 and the longitudinal extent of the punch component 120. The groove(s) 136 is/are used when connecting the tablet punch 100 to a tablet compression machine.

In embodiments where the head component 130 comprises two grooves 136, the fastening hole 133 may extend from one groove 136 to the other groove 136. In particular, the fastening hole 133 may be a through hole such that the elongate fastener 110 may be received by the fastening hole 133 at either of the grooves 136. When the fastening hole 133 is a blind hole, the fastening hole 133 may extend from one groove towards the other groove.

In the illustrated example, the head component 130 comprises a connector 134 arranged to connect the tablet punch 100 to the tablet compression machine. In FIG. 1, the connector 134 comprises a longitudinal extent which, when the punch component 120 is fixedly connected to the head component 130, is orientated substantially parallel relative to the longitudinal extent of the punch component 120. The connector 134 comprises a recess and a slanted edge to allow connection of the tablet punch 100 to the tablet compression machine. In other embodiments, the connector 134 may have a different form in order to connect the tablet punch 100 to the tablet compression machine.

The head component 130 may be integrally formed. In other words, the head component 130 may be formed as a single, undivided piece. In other embodiments, the head component 130 may be formed from multiple pieces. For example, the connector 134 may be formed separate from the rest of the head component 130 and connected, for example, via threads or another location type fixing.

The head component 130 illustrated in FIG. 1 also comprises a notch 135. When the tablet punch 100 is connected to a tablet compression machine, the notch 135 is configured to align the tablet punch 100 and restrict the rotation of the tablet punch 100 in relation to the tablet compression machine, and in relation to the hole in the die (see for example the hole 312 in the die 310 illustrated in FIG. 6).

In some embodiments, the hole 125 of the punch component 120 and the hole 132 of the head component 130 may each comprise a male and corresponding female connector, not shown. This may assist in aligning the hole 125 of the punch component 120 and the fastening hole 133, i.e., in the x-z plane, when the punch component 120 is received by the head component 130. In particular, the male and corresponding female connector may be arranged such that the rotational position of the punch component 120 is restricted and that the hole 125 of the punch component 120 is aligned with the longitudinal extent of the fastening hole 133, i.e., in the x-dimension, when the punch component 120 is received by the head component 130.

The elongate fastener 110, the punch component 120 and the head component 130 may each be formed of the same material. Alternatively, they may each be formed from different materials. The head component 120 and the punch component 130 may be formed from the same material which is different than the material which forms the elongate fastener 110. In some embodiments, the punch component 120 may be formed of (e.g., stainless) steel.

The components of the first example tablet punch enable interchangeability. For example, the same head component 130 may be used for different shaped punch components. The required punch component may be selected and fixedly connected to the head component 130 for forming the desired tablets. In other words, the same head component 130 may be used for forming tablets with different shapes, break lines and/or embossing(s).

In addition, the components enable reusability. For example, during operation, the punch component 120 may wear over time, more than the head component 130, and require replacement. Therefore, the same head component 130 may be used for a new punch component 120.

FIG. 2 illustrates the first example tablet punch 100 assembled. The connection portion 124 of the punch component 120 is received by the hole 132 in the head component 130, and the elongate fastener 110 is received by the fastening hole 133 of the head component 130 and the hole 125 of the connection portion 124. In particular, the punch component 120 is fixedly attached to the head component 130. When the punch component 120 is fixedly connected to the head component 130, the shoulder 126 abuts against the external surface 131 of the head component 130.

Each of the holes 125, 132, 133 may be considered to comprise at least one aperture and a channel. The aperture is considered to be the entrance of the hole through which the elongate fastener 110 or connection portion 124 is received by the hole 125, 132, 133. The channel is considered to be the void that accommodates the elongate fastener 110 or connection portion 124. The void is therefore at least partially filled when the elongate fastener 110 or connection portion 124 is received by the hole 125, 132, 133. The channel may extend from one aperture of the hole 125, 132, 133 to another aperture when the hole is a through hole.

FIG. 3 illustrates a cross-sectional view of the assembled first example tablet punch 100. As described above, the depth of the hole 132 in the head component 130 (i.e., in the y-dimension) is greater than the longitudinal extent of the connection portion 124. Therefore, when the punch component 120 is fixedly connected to the head component 130, a clearance 140 is formed between the end face 142 of the punch component 120 and the head component 130, i.e., an inner surface 144 of the head component 130. In other words, when the punch component 120 is fixedly connected to the head component 130, movement of the punch component 120 in the positive y-direction is restricted by the shoulder 126 of the punch component 120 which abuts against the external surface 131 of the head component 130, rather than the end face 142 abutting against the inner surface 144.

The relative positions of the hole 125 in the connection portion 124 and the fastening hole 133 in the head component 130, when the punch component 120 is fixedly connected to the head component 130, are illustrated in FIG. 3. In particular, the hole 125 of the punch component 120 is at least partially aligned with the fastening hole 133. In the illustrated example, the hole 125 of the punch component 120 and the fastening hole 133 are only partially aligned. In other words, there is a partial misalignment between the holes. This partial alignment is illustrated in the y-dimension, and is aligned with the dimension defined by the longitudinal extent of the punch component 120. In the illustrated example, the partial alignment is a result of the relative positions of the hole 125 in the longitudinal extent of the connection portion 124 and the fastening hole 133 in the head component 130, and due to the shoulder 126 and the size of the hole 132 restricting how far the connection portion 124 enters into the hole 132 of the head component 130.

The dotted line illustrated in FIG. 3 represents the location of the elongate fastener 110 within the punch component 120 and the head component 130 when they are fixedly connected. In particular, the longitudinal extent of the elongate fastener 110 is orientated substantially orthogonally relative to the longitudinal extent of the punch component 120 when received by the punch component 120 and the head component 130.

As illustrated in FIG. 3, the fastening hole 133 comprises two sections 133a and 133b, each being positioned on either side of the hole 132 of the head component 130 in the x-dimension. Portions of the longitudinal extent of the elongate fastener 110, when connecting the components, may therefore be (slightly) angled away from the dimension defined by the longitudinal extent of the fastening hole 133. This occurs as the elongate fastener 110 is received by the hole 125 in the punch component 120 from a first section 133a of the fastening hole 133, and by the second section 133b of the fastening hole 133 from the hole 125 in the punch component 120.

Therefore, the partial alignment is such that the elongate fastener 110, received by the punch component 120 and the head component 130, fixedly connects the components. As a result, the shoulder 126 forms a full contact with the external surface 131 of the head component 130. In other words, when the punch component 120 is fixedly connected to the head component 130, the surface of the shoulder 126 towards the connection portion 124 is flush with the external surface 131.

The elongate fastener 110 may therefore be formed from a material such that it can be received by the hole 125 in the punch component 120 from a first section of the fastening hole 133a, and by the second section of the fastening hole 133b from the hole 125 in the punch component 120. In other words, the elongate fastener 110 may be formed from a material that allows the elongate fastener 110 to be, at least slightly, deformed along its longitudinal extent.

During operation, the punching surface 123 of the punch component 120 experiences forces when compressing powder to form tablets. The lateral forces experienced by the punch component 120 during compression of the powder can be redirected to the head component 130 via the full contact made between the shoulder 126 of the punch component 120 and the external surface 131 of the head component 130. This therefore advantageously redirects the forces away from the punch component 120 and improves the longevity of the punch component 120. In particular, the full contact made between the shoulder 126 of the punch component 120 and the external surface of the head component 130 directs the forces away from the connection made between the connection portion 124 and the elongate fastener 110.

In addition, the shoulder 126 abutting against the external surface 131 of the head component 130 also restricts lateral movement of the punch component 120 relative to the head component 130 during operation. This ensures that the tablet punch 100 as a whole remains correctly positioned in relation to the tablet compression machine and the corresponding die.

The elongate fastener 110 also restricts rotational movement of the punch component 120 in relation to the head component 130 during operation.

FIG. 4 illustrates an exploded view of a second example tablet punch 200. The second example tablet punch 200 comprises two punch components 220a and 220b, where each punch component is the same as described above. In addition, the head component 230 comprises two holes 232a and 232b, each hole for receiving a respective punch component. Apart from their relative positions in the head component, the holes 232a and 232b are the same as described above. The fastening hole 233 in the head component 230 differs from the fastening hole 133 described above in that it comprises three sections, extending from the two holes 232a and 232b.

Otherwise, the second example tablet punch 200 is the same as the first example tablet punch 100 described above.

FIG. 5 illustrates the second example tablet punch 200 assembled. The two punch components 220a and 220b are fixedly connected to the head component 230 by the elongate fastener 110 in the same manner as described above in relation to the first example tablet punch 100. In particular, each punch component is only partially aligned with the fastening hole 233 and has a clearance with an inner surface of the head component 230, as described above in relation to FIG. 3.

Advantageously, when the punch components 220a and 220b are fixedly connected to the head component 230, the distance between the two punch components 220a and 220b, specifically the distance between the punching surfaces of the components, can be smaller than that achieved when the tablet punch is made as a single, undivided piece. This therefore allows the diameter of the two punch components 220a and 220b to be larger than when the tablet punch is formed as a single, undivided piece. The distance is restricted based on the relative positions and sizes of the shoulders of the punch components 220a and 220b.

FIG. 6 illustrates a system 300 comprising two assembled tablet punches 100a and 100b and a corresponding die 310. In the illustrated example, the tablet punches are the first example tablet punch 100 and the upper tablet punch 100a comprises a punch component having a longer longitudinal extent than the punch component of the lower tablet punch 100b.

The die 310 comprises a single through hole 312 for receiving the punch component of the two tablet punches 100a and 100b. In embodiments where the tablet punches comprise a plurality of punch components, the die comprises a respective hole for receiving each punch component. The die 310 also comprises a die centrifugal fill aperture 314 for receiving powder from a hopper above the tablet compression machine.

During operation, each tablet punch 100a and 100b moves (i.e., vertically in the y-dimension) relative to the die 310, and to each other. This movement causes the tablet punches 100a and 100b to compress powder in the die 310 to form tablets, to allow the formed tablet to be removed from the die 310 and for additional powder to be positioned for subsequent compression. In some embodiments, the punch component of the upper tablet punch 100a may remain at least partially within the die 310 during operation.

When connecting the tablet punches 100a and 100b and the die 310 to the tablet compression machine, the tablet punches 100a and 100b may be partially received by the hole 312 in the die 310. In particular, the punch components of the tablet punches 100a and 100b may each be positioned in the die 310, and the system 300 is installed and connected to the tablet compression machine at the same time. An apparatus, not shown, may be used to contact the system 300 at the grooves of the two tablet punches 100a and 100b during installation.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. For example, the spacing, shape and/or size of the hole 132 in the head component 130 and the connection portion 124 of the punch component 120 need not be the same as those illustrated in FIGS. 1-6. The shape and/or size of the punching portion 122 need not be the same as those illustrated in FIGS. 1-6. The shape of the punching portion 122 need not be the same as the connection portion 124 as illustrated in FIGS. 1-6. The punching surface 123 need not be circular in shape as illustrated in FIGS. 1-6. The shape and/or size of the elongate fastener 110 need not be the same as those illustrated in FIGS. 1, 3 and 4. The shape and/or size of the head component 130 need not be the same as those illustrated in FIGS. 1-6.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavouring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A tablet punch comprising:
an elongate fastener having a longitudinal extent;
one or more punch components, each punch component having a longitudinal extent and being arranged to receive the elongate fastener; and
a head component, configured to connect the tablet punch to a tablet compression machine, arranged to receive the one or more punch components and the elongate fastener such that the elongate fastener fixedly connects the one or more punch components and the head component together;
wherein, when the elongate fastener fixedly connects the head component and the one or more punch components together, the longitudinal extent of the elongate fastener is orientated substantially orthogonally relative to the longitudinal extent of the one or more punch components.

2. The tablet punch according to claim 1, wherein the head component comprises one or more respective holes arranged to receive a portion of the one or more punch components when the one or more punch components are fixedly connected to the head component.

3. The tablet punch according to claim 2, wherein the head component comprises a fastening hole arranged to receive the elongate fastener when the one or more punch components are fixedly connected to the head component.

4. The tablet punch according to claim 3, wherein the fastening hole has a longitudinal extent that is orientated substantially orthogonally relative to the longitudinal extent of the one or more punch components when the one or more punch components are fixedly connected to the head component.

5. The tablet punch according to claim 3, wherein each punch component comprises a hole arranged to receive the elongate fastener when the one or more punch components are fixedly connected to the head component.

6. The tablet punch according to claim 5, wherein the hole of each punch component has a longitudinal extent that is orientated substantially orthogonally relative to the longitudinal extent of the punch component.

7. The tablet punch according to claim 5, wherein the hole of each punch component is a through hole.

8. The tablet punch according to claim 5, wherein, when the one or more punch components are fixedly connected to the head component, the hole of the punch components is at least partially aligned with the fastening hole.

9. The tablet punch according to claim 1, wherein, when the one or more punch components are fixedly connected to the head component, a clearance is formed between an end face of the punch component and the head component.

10. The tablet punch according to claim 1, wherein each punch component comprises a shoulder arranged to abut against an external surface of the head component when the punch component is fixedly connected to the head component.

11. The tablet punch according to claim 10, wherein the head component comprises one or more respective holes arranged to receive a portion of the one or more punch components when the one or more punch components are fixedly connected to the head component, wherein the shoulder is intermediate a punching portion and a connection portion of the punch component, the respective holes of the head component are arranged to receive the connection portion of the punch component, and wherein the depth of the respective holes is greater than a longitudinal extent of the connection portion.

12. The tablet punch according to claim 10, wherein, when the one or more punch components are fixedly connected to the head component, the hole of the punch components is at least partially aligned with the fastening hole, and when the shoulder abuts against an external surface of the head component, the hole of the punch components and the fastening hole are only partially aligned.

13. The tablet punch according to claim 1, wherein the elongate fastener is a coiled spring pin.

14. The tablet punch according to claim 1, wherein the head component comprises a notch configured to align the tablet punch when connected to the tablet compression machine.

15. The tablet punch according to claim 1, wherein the head component comprises a connector arranged to connect the tablet punch to the tablet compression machine, the connector comprises a recess and a slanted edge.

16. The tablet punch according to claim 1, wherein the head component comprises at least one groove having a longitudinal extent, and wherein, when the one or more punch components is fixedly connected to the head component, the longitudinal extent of the at least one groove is orientated substantially orthogonally relative to the longitudinal extent of the elongate fastener and the longitudinal extent of the one or more punch components.

17. The tablet punch according to claim 16, wherein the head component comprises a fastening hole arranged to receive the elongate fastener when the one or more punch components are fixedly connected to the head component, and wherein the head component comprises two grooves and the fastening hole extends from one groove to the other groove.

18. A tablet punch comprising:
one or more punch components, each punch component having a shoulder;
a head component, configured to connect the tablet punch to a tablet compression machine, arranged to receive the one or more punch components; and
a fastener configured to fixedly connect the head component and the one or more punch components together;
wherein, when the one or more punch components are received by the head component and fixedly connected by the fastener, the shoulder of each punch component abuts against an external surface of the head component.

19. The tablet punch according to claim 18, wherein, when the one or more punch components are fixedly connected to the head component, a clearance is formed between an end face of the punch component and the head component.

20. The tablet punch according to claim 18, wherein the head component comprises one or more respective holes arranged to receive a portion of the one or more punch components when the one or more punch components are fixedly connected to the head component.

21. The tablet punch according to claim 20, wherein the shoulder is intermediate a punching portion and a connection portion of the punch component, and the respective holes of the head component are arranged to receive the connection portion of the punch component.

22. The tablet punch according to claim 18, wherein the head component comprises a fastening hole arranged to receive the fastener when the one or more punch components are fixedly connected to the head component.

23. The tablet punch according to claim 22, wherein each punch component comprises a hole arranged to receive the fastener when the one or more punch components are fixedly connected to the head component, the hole of the punch components has a longitudinal extent that is orientated substantially orthogonally relative to a longitudinal extent of the one or more punch components.

24. The tablet punch according to claim 23, wherein, when the shoulder abuts against an external surface of the head component, the hole of the punch components and the fastening hole are only partially aligned.

25. A tablet punch comprising:
one or more punch components;
a head component, configured to connect the tablet punch to a tablet compression machine, comprising one or more respective holes to receive the one or more punch components; and
a fastener configured to fixedly connect the head component and the one or more punch components together;
wherein, when the head component and the one or more punch components are fixedly connected by the fastener, a portion of the one or more punch components is located within the one or more respective holes.
